(19) United States
(12) Patent Application Publication
(10) Pub. No.: US 2015/0052145 A1
(43) Pub. Date: Feb. 19, 2015

(54) ELECTRONIC DEVICE AND METHOD CAPABLE OF SEARCHING APPLICATION

(71) Applicant: Samsung Electronics Co., Ltd., Gyeonggi-do (KR)

(72) Inventors: Jai-Young Choi, Seoul (KR); Soon-Hwan Kwon, Gyeonggi-do (KR)

(21) Appl. No.: 14/459,038

(22) Filed: Aug. 13, 2014

(30) Foreign Application Priority Data
Aug. 13, 2013 (KR) 10-2013-0096054

(51) Int. Cl. G06F 17/30; H04L 29/08

(52) U.S. Cl. CPC G06F 17/30864; G06F 17/30598; H04L 67/10
USPC 707/740; 707/770

(57) ABSTRACT

A method of operating an electronic device. The method includes receiving application group information including information on at least one interested application, and transmitting the received application group information to a server so that another electronic device can utilize the information.

### PRIORITY

The present application is related to and claims the benefit under 35 U.S.C. §119(a) of a Korean patent application filed in the Korean Intellectual Property Office on Aug. 13, 2013 and assigned Serial No. 10-2013-0096054, the entire disclosure of which is hereby incorporated by reference.

### TECHNICAL FIELD

The present disclosure relates to an electronic device and method capable of searching applications.

### BACKGROUND

With the development of various applications, a user can search for and purchase an application desired by the user by accessing a specific store capable of downloading the application.

However, although the various applications are continuously under development, the user has to manually search innumerable applications one by one inconveniently to directly select and purchase the application desired by the user. In addition, it is difficult for the user to access all stores which sell the applications in reality, and thus there is a limitation in that the various applications cannot be searched for and purchased by accessing all the stores.

Accordingly, there is an urgent need to provide an apparatus and method for providing an application list classified for each category to allow a user to easily search for an application and capable of conveniently recommending an application between users who use different stores.

### SUMMARY

To address the above-discussed deficiencies, it is a primary object to provide an apparatus and method in which an application list updated on a real-time basis can be provided to another user as long as an application list to be recommended is provided on the basis of a pre-set format from the perspective of a user who recommends an application, thereby being able to satisfy various demands of a user.

Another aspect of the present disclosure is to provide an apparatus and method in which, from the perspective of a user who intends to search for an application, an application list written in a pre-set format can be provided, the application can be easily searched for, and an application related to an application provided in a store inaccessible by the user can be provided, thereby being able to improve user's convenience.

In accordance with an aspect of the present disclosure, a method of operating an electronic device is provided. The method includes receiving application group information including information on at least one interested application, and transmitting the received application group information to a server so that another electronic device can utilize the information.

In addition, the information on the application may include at least one of application Uniform Resource Locator (URL) information, application name information, application package name information, application description information, and application screenshot information.

In addition, the application group information may include at least one of application group name information, application category information, application editor information, application tag information, application description information, and application update information.

In addition, the method may further include receiving at least one of automatic replace information and dynamic search information as option information.

In addition, if the another electronic device does not have an account capable of accessing a store in which the interested application is registered, the automatic replace information may be information regarding whether to replace the interested application to an application related to the interested application among applications stored in another store which has an account accessible by the second electronic device.

In addition, the dynamic search information may be information regarding whether to update application group information transmitted from the server.

In addition, the method may further include editing the application group information by accessing the server.

In addition, the method may further include, if the application group information is updated, receiving information notifying that the application group information is updated from the server.

In accordance with another aspect of the present disclosure, a method of operating an electronic device is provided. The method includes accessing a server to search for application group information including information on at least one interested application, receiving data regarding at least one piece of application group information from the server among a plurality of pieces of application group information, and downloading an interested application and at least one application among applications related to the interested application from a store connected to the server on the basis of the received data.

In addition, the information on the application may include at least one of application URL information, application name information, application package name information, application description information, and application screenshot information.

In addition, the application group information may include at least one of application group name information, application category information, application editor information, application tag information, application description information, and application update information.

In addition, the method may further include receiving at least one piece of application group information selected from the plurality of pieces of application group information, and requesting data regarding the selected at least one piece of application group information to the server.

In addition, the downloading of the interested application and the at least one application among applications related to the interested application from the store connected to the server on the basis of the received data may include, if the received data includes information on the interested application, accessing a store in which the interested application is stored, requesting the accessed store to download the interested application, and downloading the interested application from the accessed store.

In addition, the downloading of the interested application and the at least one application among applications related to the interested application from the store connected to the server on the basis of the received data may include, if the received data includes information on an application related to the interested application, accessing a store in which the application related to the interested application is stored, requesting the accessed store to download the application related to the interested application, and downloading the application related to the interested application from the accessed store.

In accordance with another aspect of the present disclosure, a method of operating a server is provided. The method includes receiving application group information including information on at least one interested application from a first electronic device, receiving a request of data regarding the at least one piece of application group information among the plurality of pieces of received application information from a second electronic device, and transmitting data regarding requested application group information by reflecting option information configured to the second electronic device and updated metadata information.

In addition, the method may further include accessing at least one registered store to collect metadata information regarding a plurality of applications stored in each store, classifying the collected metadata information according to a pre-set category, and storing the classified information.

In addition, the method may further include accessing at least one registered store to collect and store metadata information regarding a plurality of applications stored in each store.

In addition, the metadata information may include at least one of application name information, application vender information, application registration information, application version information, information regarding the number of application reviews, application rating information, application support operating system information, application support language information, and application usage age information.

In addition, the information on the application may include at least one of application URL information, application name information, application package name information, application description information, and application screenshot information.

In addition, the information on the application may include application group name information, application category information, application editor information, application tag information, application description information, and application update information.

In addition, the option information may include at least one of automatic replace information and dynamic search information.

In addition, if the second electronic device does not have an account capable of accessing a store in which an interested application is registered, the automatic replace information may be information regarding whether to replace the interested application to an application related to the interested application among applications stored in another store which has an account accessible by the second electronic device.

In addition, the dynamic search information may be information regarding whether to update application group information transmitted from the first electronic device.

In addition, the method may further include storing the application group information received from the first electronic device, classifying the stored application group information according to a pre-set category, extracting URL information of each interested application included in the classified application group information, and mapping an application related to each interested application to each interested application, by comparing metadata information regarding a stored application on the basis of URL information of an extracted interested application.

In addition, the transmitting of the data regarding the requested application group information by reflecting the option information configured to the second electronic device and the updated metadata information may include confirming at least one interested application included in application group information requested from the second electronic device, determining whether the second electronic device has an account for a store in which the confirmed interested application is stored, and if it is determined that the second electronic device has the account for the store in which the interested application is stored, transmitting information on the interested application to the second electronic device.

In addition, if it is determined that the second electronic device does not have the account for the store in which the interested application is stored, the method may further include transmitting information on an application related to the interested application to the second electronic device.

In addition, the method may further include confirming that the application group information is updated, and transmitting information notifying that the application group information is updated to the first electronic device.

In accordance with another aspect of the present disclosure, an electronic device is provided. The electronic device includes a display unit for receiving application group information including information on at least one interested application, and a communication unit for transmitting the received application group information to a server so that another electronic device can utilize the information.

In addition, the information on the application may include at least one of application URL information, application name information, application package name information, application description information, and application screenshot information.

In addition, the application group information may include at least one of application group name information, application category information, application editor information, application tag information, application description information, and application update information.

In addition, the display unit may receive at least one of automatic replace information and dynamic search information as option information.

In addition, if the another electronic device does not have an account capable of accessing a store in which the interested application is registered, the automatic replace information may be information regarding whether to replace the interested application to an application related to the interested application among applications stored in another store which has an account accessible by the second electronic device.

In addition, the dynamic search information may be information regarding whether to update application group information transmitted from the server.

In addition, the electronic device may further include a processor for editing the application group information by accessing the server.

In addition, if the application group information is updated, the communication unit may receive information notifying that the application group information is updated from the server.

In accordance with another aspect of the present disclosure, an electronic device is provided. The electronic device includes a processor for accessing a server to search for application group information including information on at least one interested application, and a communication unit for receiving data regarding at least one piece of application group information from the server among a plurality of pieces of application group information, and for downloading an interested application and at least one application among applications related to the interested application from a store connected to the server on the basis of the received data.

In addition, the information on the application may include at least one of application URL information, application name information, application package name information, application description information, and application screenshot information.

In addition, the application group information may include at least one of application group name information, application category information, application editor information, application tag information, application description information, and application update information.

In addition, the electronic device may further include a display unit for receiving at least one piece of application group information selected from the plurality of pieces of application group information, wherein the communication unit requests the server to send the data regarding the selected at least one piece of application group information.

In addition, if the received data includes information on the interested application, the communication unit may access a store in which the interested application is stored, request the accessed store to download the interested application, and download the interested application from the accessed store.

In addition, if the received data includes information on an application related to the interested application, the communication unit may access a store in which the application related to the interested application is stored, request the accessed store to download the application related to the interested application, and download the application related to the interested application from the accessed store.

In accordance with another aspect of the present disclosure, a server is provided. The service includes a communication unit for receiving application group information including information on at least one interested application from a first electronic device, for receiving a request of data regarding the at least one piece of application group information among the plurality of pieces of received application information from a second electronic device, and for transmitting data regarding requested application group information by reflecting option information configured to the second electronic device and updated metadata information, and a storage unit for storing data controlled in the communication unit.

In addition, the server may further include a controller for accessing at least one registered store to collect metadata information regarding a plurality of applications stored in each store, and for classifying the collected metadata information according to a pre-set category, wherein the storage unit stores the classified information.

In addition, the storage unit may access at least one registered store to collect and store metadata information regarding a plurality of applications stored in each store.

In addition, the metadata information may include at least one of application name information, application vender information, application registration information, application version information, information regarding the number of application reviews, application rating information, application support operating system information, application support language information, and application usage age information.

In addition, the information on the application may include at least one of application URL information, application name information, application package name information, application description information, and application screenshot information.

In addition, the information on the application may include application group name information, application category information, application editor information, application tag information, application description information, and application update information.

In addition, the option information may include at least one of automatic replace information and dynamic search information.

In addition, if the second electronic device does not have an account capable of accessing a store in which an interested application is registered, the automatic replace information may be information regarding whether to replace the interested application to an application related to the interested application among applications stored in another store which has an account accessible by the second electronic device.

In addition, the dynamic search information may be information regarding whether to update application group information transmitted from the first electronic device.

In addition, the storage unit may store the application group information received from the first electronic device, and the server may further include a controller for classifying the stored application group information according to a pre-set category, for extracting URL information of each interested application included in the classified application group information, and for mapping an application related to each interested application to each interested application, by comparing metadata information regarding a stored application on the basis of URL information of an extracted interested application.

In addition, the server may further include a controller for confirming at least one interested application included in application group information requested from the second electronic device, and for determining whether the second electronic device has an account for a store in which the confirmed interested application is stored, wherein if it is determined that the second electronic device has the account for the store in which the interested application is stored, the communication unit transmits information on the interested application to the second electronic device.

In addition, if it is determined that the second electronic device does not have the account for the store in which the interested application is stored, the communication unit may transmit information on an application related to the interested application to the second electronic device.

In addition, the server may further include a controller for confirming that the application group information is updated, wherein the communication unit transmits information notifying that the application group information is updated to the first electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an electronic device according to various exemplary embodiments of the present disclosure;

FIG. 2 is a block diagram of a hardware according to various exemplary embodiments of the present disclosure;

FIG. 3 is a block diagram of a programming unit according to an exemplary embodiment of the present disclosure;

FIG. 4 is a diagram illustrating an overall description of an electronic device capable of integrally searching for an application according to an exemplary embodiment of the present disclosure;

FIG. 5 illustrates an example of application group information according to an exemplary embodiment of the present disclosure;

FIG. 6 is a flowchart illustrating an operation of an electronic device for recommending an interested application according to an exemplary embodiment of the present disclosure;

FIG. 7 is a flowchart illustrating an operation of an electronic device for searching for an interested application according to an exemplary embodiment of the present disclosure;

FIG. 8 is a flowchart illustrating an operation of a server according to an exemplary embodiment of the present disclosure;

FIG. 9 is a flowchart illustrating an electronic device capable of integrally searching for an application according to an exemplary embodiment of the present disclosure;

FIG. 10 is a flowchart illustrating a method of an electronic device for recommending an interested application according to an exemplary embodiment of the present disclosure;

FIG. 11 is a flowchart illustrating a method of an electronic device for searching for an interested application according to an exemplary embodiment of the present disclosure;

FIG. 12 is a flowchart illustrating a method of a server according to an exemplary embodiment of the present disclosure; and

FIG. 13 is a block diagram illustrating a structure of a server according to an exemplary embodiment of the present disclosure.

### DETAILED DESCRIPTION

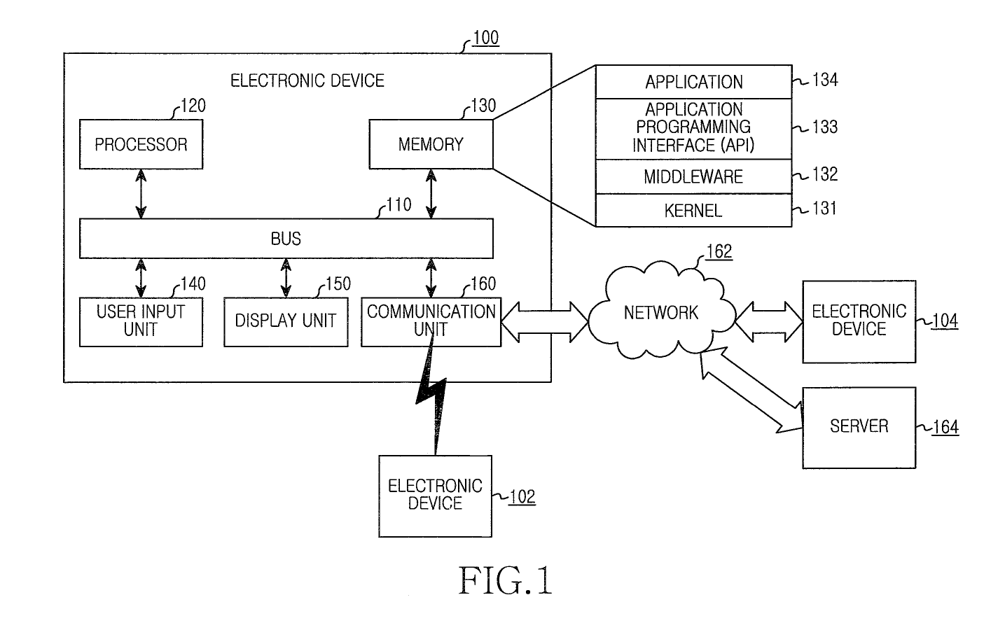

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Hereinafter, the present disclosure is described with reference to the accompanying drawings. While the present disclosure is susceptible to various modifications and alternative forms, a specific embodiment thereof has been shown by way of example in the drawings and will herein be described in detail. It should be understood, however, that it is not intended to limit the disclosure to the particular form disclosed, but, on the contrary, the intention is to cover all modifications, equivalent, and alternatives falling within the spirit and scope of the disclosure as defined by the appended claims. Like reference numerals denote like constitutional elements throughout the drawings.

An electronic device according to the present disclosure may be a device including a communication function. For example, the electronic device may be one or more combinations of various devices such as a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, an electronic bracelet, an electronic necklace, an electronic appcessory, a camera, a wearable device, an electronic clock, a wrist watch, a smart white appliance (e.g., a refrigerator, an air conditioner, a cleaner, an artificial intelligent robot, a Television (TV), a Digital Video Disk (DVD) player, an audio, an oven, a microwave oven, a washing machine, an air purifier, an electronic picture frame, etc.), various medical devices (e.g., Magnetic Resonance Angiography (MRA), Magnetic Resonance Imaging (MRI), Computed Tomography (CR), imaging equipment, ultrasonic instrument, etc.), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, a car infotainment device, an electronic equipment for ship (e.g., a vessel navigation device, a gyro compass, etc.), avionics, a security device, an electronic costume, an electronic key, a camcorder, game consoles, a Head-Mounted Display (HMD), a flat panel display device, an electronic album, a furniture or a part of building/constructions including a communication function, an electronic board, an electronic signature receiving device, a projector, etc. It is apparent to those ordinarily skilled in the art that the electronic device according to the present disclosure is not limited to the aforementioned devices.

FIG. 1 is a block diagram of an electronic device according to various exemplary embodiments of the present disclosure. Referring to FIG. 1, an electronic device 100 may include a bus 110, a processor 120, a memory 130, a user input unit 140, a display unit 150, or a communication unit 160.

The bus 110 may be a circuit for connecting the aforementioned constitutional elements and for delivering communication (e.g., a control message) between the aforementioned constitutional elements.

For example, the processor 120 may receive an instruction from other constitutional elements (e.g., the memory 130, the user input unit 140, the display unit 150, the communication unit 160, etc.), and thus may interpret the received instruction and execute arithmetic or data processing according to the interpreted instruction.

The memory 130 may store an instruction or data received from the processor 120 or other constitutional elements (e.g., the user input unit 140, the display unit 150, the communication unit 160, etc.) or generated by the processor 120 or other constitutional elements. The memory 130 may include programming modules such as a kernel 131, a middleware 132, an Application Programming Interface (API) 133, an application 134, etc. Each of the aforementioned programming modules may consist of software, firmware, or hardware entities or may consist of at least two or more combinations thereof.

The kernel 131 may control or manage the remaining other programming modules, for example, system resources (e.g., the bus 110, the processor 120, the memory 130, etc.) used to execute an operation or function implemented in the middleware 132, the API 133, or the application 134. In addition, the kernel 131 may provide a controllable or manageable interface by accessing individual constitutional elements of the electronic device 100 in the middleware 132, the API 133, or the application 134.

The middleware 132 may perform an intermediary role so that the API 133 or the application 134 communicates with the kernel 131 to exchange data. In addition, regarding task requests received from the (plurality of) applications 134, the middleware 132 may perform load balancing for the task request by using a method of assigning a priority or the like capable of using a system resource (e.g., the bus 110, the processor 120, the memory 130, etc.) of the electronic device 100 to at least one application among the (plurality of) applications 134.

The API 133 may include at least one interface or function for file control, window control, video processing, or character control, etc., as an interface capable of controlling a function provided by the application 134 in the kernel 131 or the middleware 132.

The user input unit 140 may receive an instruction or data from a user and deliver the instruction to the processor 120 or the memory 130 via the bus 110. The display unit 150 may display video, image, data, etc., to the user.

The communication unit 160 may connect communication between another electronic device 102 and the electronic device 100. The communication unit 160 may support a specific near-field communication protocol (e.g., Wireless Fidelity (WiFi), Bluetooth (BT), Near Field Communication (NFC), or specific network communication 162 (e.g., Internet, Local Area Network (LAN), Wide Area Network (WAN), telecommunication network, cellular network, satellite network, Plain Old Telephone Service (POTS), etc.). Each of the electronic devices 102 and 104 may be a device which is the same (e.g., the same type) as the electronic device 100 or may be a different (e.g., a different type) device.

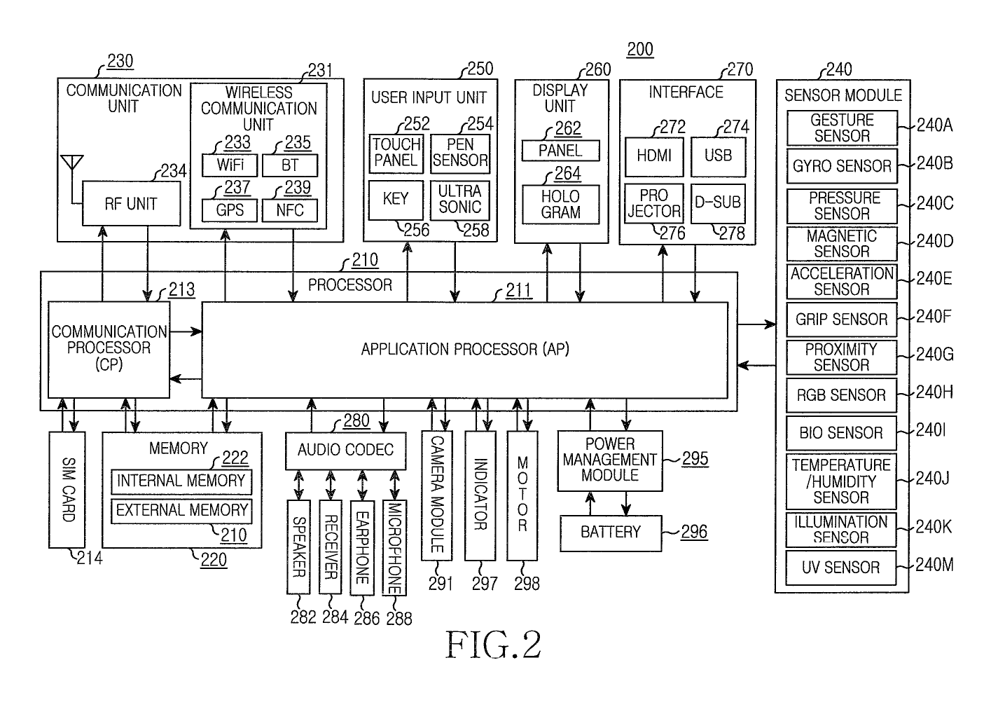

FIG. 2 is a block diagram of hardware according to various exemplary embodiments of the present disclosure. Hardware 200 may be the electronic device 100 of FIG. 1. Referring to FIG. 2, the hardware 200 may include one or more processors 210, a Subscriber Identification Module (SIM) card 214, a memory 220, a communication unit 230, a sensor module 240, a user input unit 250, a display unit 260, an interface 270, an audio codec 280, a camera module 291, a power management module 295, a battery 296, an indicator 297, or a motor 298.

The processors 210 (e.g., the aforementioned processor 120) may include one or more Application Processors (APs) 211 or one or more Communication Processors (CPs) 213. The processor 210 may be the processor 120 of FIG. 1. Although described in FIG. 2 that the AP 211 and the CP 213 are included in the processor 210, the AP 211 and the CP 213 may be respectively included in different Integrated Circuit (IC) packages. In one exemplary embodiment, the AP 211 and the CP 213 may be included in one IC package. In the present disclosure, the processor 210 may access a server to edit application group information, and may access the server to search for application group information including information on at least one interested application.

The AP 211 may control a plurality of hardware or software constitutional elements connected to the AP 211 by driving an operating system or an application program, and may perform a variety of data processing and computation including multimedia data. The AP 211 may be implemented with a System on Chip (SoC). According to one exemplary embodiment, the processor 210 may further include a Graphic Processing Unit (GPU, not shown).

The CP 213 may perform a function of managing a data link and converting a communication protocol in communication between other electronic devices connected with an electronic device (e.g., the electronic device 100) including the hardware 200 through a network. The CP 213 may be implemented with a SoC. According to one exemplary embodiment, the CP 213 may perform at least a part of a multimedia control function. The CP 213 may identify and authenticate a terminal in a communication network by using a Subscriber Identification Module (SIM) (e.g., the SIM card 214). In addition, the CP 213 may provide the user with services such as voice telephony, video telephony, text messages, packet data, etc.

In addition, the CP 213 may control data transmission/reception of the communication unit 230. Although illustrated in FIG. 2 that the constitutional elements such as the CP 213, the power management module 295, the memory 220, etc., are separate constitutional elements independent of the AP 211, according to one exemplary embodiment, it is also possible to implement such that the AP 211 includes at least a part (e.g., the CP 213) of the aforementioned constitution elements.

According to one exemplary embodiment, the AP 211 or the CP 213 may load an instruction or data, received from a non-volatile memory each connected thereto or at least one of other constitutional elements, to a volatile memory and then may process the instruction or data. In addition, the AP 211 or the CP 213 may store data, received from the at least one of other constitutional elements or generated by the at least one of other constitutional elements, into the non-volatile memory.

The SIM card 214 may be a card in which a SIM is implemented, and may be inserted to a slot formed at a specific location of the electronic device. The SIM card 214 may include unique identification information (e.g., an Integrated Circuit Card Identifier (ICCID)) or subscriber information (e.g., an International Mobile Subscriber Identity (IMSI)).

The memory 220 may include an internal memory 222 or an external memory 224. The memory 220 may be the memory 130 of FIG. 1. The internal memory 222 may include at least one of a volatile memory (e.g., a Dynamic RAM (DRAM), a Static RAM (SRAM), a Synchronous Dynamic RAM (SDRAM), etc.) or a non-volatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, a NAND flash memory, a NOR flash memory, etc.). According to one exemplary embodiment, the internal memory 222 may have a form of a Solid State Drive (SSD). The external memory 224 may further include Compact Flash (CF), Secure Digital (SD), Micro Secure Digital (Micro-SD), Mini Secure digital (Mini-SD), extreme Digital (xD), memory stick, etc.

The communication unit 230 may include a wireless communication unit 231 or a Radio Frequency (RF) unit 234. The communication unit 230 may be the communication unit 160 of FIG. 1. The wireless communication unit 231 may include a WiFi 233, a BlueTooth (BT) 235, a Global Positioning System (GPS) 237, or a near field communication (NFC) 239. For example, the wireless communication unit 231 may provide a wireless communication function by using a radio frequency. In addition or in general, the wireless communication unit 231 may include a network interface (e.g., a LAN card), modem, or the like for connecting the hardware 200 to a network (e.g., Internet, LAN, WAN, telecommunication network, cellular network, satellite network, POTS, or the like). In the present disclosure, the communication unit 230 may transmit received application group information to the server so that the application group information is utilized in another electronic device. In addition, if the application group information is updated, the communication unit 230 may receive information for notifying that the application group information is updated from the server. In addition, the communication unit 230 may receive data regarding at least one piece of application group information from the server among a plurality of pieces of application group information, and may download an interested application and at least one application among applications related to the interested application from a store connected to the server on the basis of the received data. In addition, the communication unit 230 may request the server to send the data regarding at least selected one piece of application group information. In addition, if the received data includes information regarding the interested application, the communication unit 230 may access a store in which the interested application is stored and thus request the accessed store to download the interested application, and then may download the interested application from the accessed store. In addition, if the received data includes information on the application related to the interested application, the communication unit 230 may access the store in which the application related to the interested application is stored and thus request the store to download the application related to the interested application, and then may download the application related to the interested application from the accessed store.

The RF unit 234 may serve to transmit/receive data, for example, to transmit/receive an RF signal or a paged electronic signal. Although not shown, the RF unit 234 may include a transceiver, a Power Amp Module (PAM), a frequency filter, a Low Noise Amplifier (LNA), etc. In addition, the RF unit 234 may further include a component, e.g., a conductor, a conducting wire, etc., for transmitting/receiving a radio wave on a free space in wireless communication.

The sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a Red, Green, Blue (RGB) sensor 240H, a bio sensor 240I, a temperature/humidity sensor 240J, an illumination sensor 240K, and an Ultra Violet (UV) sensor 240M. The sensor module 240 may measure a physical quantity or detect an operation state of the electronic device, and thus may convert the measured or detected information into an electric signal. In addition/in general, the sensor module 240 may include an E-node sensor (not shown), an ElectroMyoGraphy (EMG) sensor (not shown), an ElectroEncephaloGram (EEG) sensor (not shown), an ElectroCardioGram (ECG) sensor (not shown), a fingerprint sensor, etc. The sensor module 240 may further include a control circuit for controlling at least one or more sensors included therein.

The user input unit 250 may include a touch panel 252, a (digital) pen sensor 254, a key 256, or an ultrasonic input unit 258. The user input unit 250 may be the user input unit 140 of FIG. 1. The touch panel 252 may recognize a touch input by using at least one of an electrostatic type, a pressure-sensitive type, and an ultrasonic type. In addition, the touch panel 252 may further include a controller (not shown). In case of the electrostatic type, not only direct touch but also proximity recognition is also possible. The touch penal 252 may further include a tactile layer. In this case, the touch panel 252 may provide the user with a tactile reaction.

The (digital) pen sensor 254 may be implemented by using the same or similar method of receiving a touch input of the user or by using an additional sheet for recognition. The key 256 may be a keypad or a touch key. The ultrasonic input unit 258 is a device by which a terminal detects a sound wave through a microphone (e.g., a microphone 288) by using a pen which generates an ultrasonic signal, and is a device capable of radio recognition. According to one exemplary embodiment, the hardware 200 may use the communication unit 230 to receive a user input from an external device (e.g., a network, a computer, or a server) connected thereto.

The display unit 260 may include a panel 262 or a hologram 264. The display unit 260 may be the display unit 150 of FIG. 1. The panel 262 may be a Liquid-Crystal Display (LCD), an Active-Matrix Organic Light-Emitting Diode (AM-OLED), etc. The panel 262 may be implemented in a flexible, transparent, or wearable manner. The panel 262 may be constructed as one unit with the touch panel 252. The hologram 264 may use an interference of light and show a stereoscopic image in the air. According to one exemplary embodiment, the display unit 260 may further include a control circuit for controlling the panel 262 or the hologram 264. In the present disclosure, the display unit 260 may receive application group information including information on at least one interested application, and may receive at least one piece of application group information selected from a plurality of application group information.

The interface 270 may include a High-Definition Multimedia Interface (HDMI) 272, a Universal Serial Bus (USB) 274, a projector 276, or a D-subminiature (D-sub) 278. In addition or in general, the interface 270 may include Secure Digital (SD)/Multi-Media Card (MMC) (not shown) or Infrared Data Association (IrDA) (not shown).

The audio codec 280 may bilaterally convert a voice and electronic signal. The audio codec 280 may convert audio information which is input or output through a speaker 282, a receiver 284, an earphone 286, the microphone 288, etc.

The camera module 291 is a device for image and video capturing, and according to one exemplary embodiment, may include one or more image sensors (e.g., a front lens or a rear lens), an Image Signal Processor (ISP) (not shown), or a flash LED (not shown).

The power management module 295 may manage power of the hardware 200. Although not shown, the power management module 295 may include a Power Management Integrated Circuit (PMIC), a charger Integrated Circuit (IC), or a battery fuel gauge.

The PMIC may be equipped inside an IC or SoC semiconductor. Charging may be classified into wired charging and wireless charging. The charger IC may charge a battery, and may avoid over-voltage or over-current flowing from a charger. According to one exemplary embodiment, the charger IC may further include a charger IC for at least one of the wired charging and the wireless charging. The wireless charging may be classified into a magnetic resonance type, a magnetic induction type, and an electromagnetic type. An additional circuit for the wireless charging may be added, such as a coil loop, a resonant circuit, a rectifier, etc.

The battery gauge may measure a residual quantity of the battery 296 and a voltage, current, and temperature during charging. The battery 296 may generate electricity to supply power source, and may be a rechargeable battery.

The indicator 297 may indicate a specific state, e.g., a booting state, a message state, a charging state, etc., of the hardware 200 or a part thereof (e.g., the AP 211). The motor 298 may convert an electric signal into a mechanical vibration. The MCU 299 may control the sensor module 240.

Although not shown, the hardware 200 may include a processing unit (e.g., a GPU) for supporting mobile TV. The processing unit for supporting mobile TV may process media data according to a protocol of, for example, Digital Multimedia Broadcasting (DMB), Digital Video Broadcasting (DVB), media flow, etc.

Names of the aforementioned constitutional elements of the hardware according to the present disclosure may vary depending on a type of electronic device. The hardware of the present disclosure may include at least one of the aforementioned constitutional elements. Some of the constitutional elements may be omitted, or additional other constitutional elements may be further included. In addition, some of the constitutional elements of the hardware of the present disclosure may be combined and constructed to one entity, so as to equally perform functions of corresponding constitutional elements before combination.

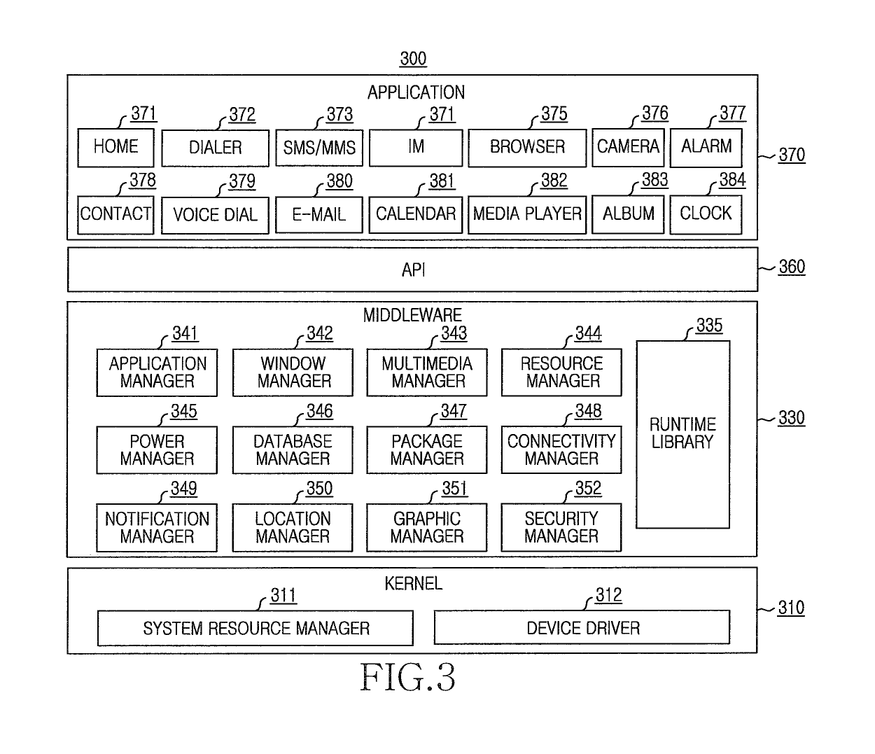

FIG. 3 is a block diagram of a programming module according to an exemplary embodiment of the present disclosure. A programming module 300 may be included (e.g., stored) in the electronic device 100 (e.g., the memory 130) of FIG. 1. At least some parts of the programming module 300 may consist of software, firmware, hardware, or a combination of at least two or more of them. The programming module 300 may include an Operating System (OS) implemented in a hardware (e.g., the hardware 200) and controlling a resource related to an electronic device (e.g., the electronic device 100) or various applications (e.g., the application 134) driven on the OS. For example, the OS may be Android, iOS, Windows, Symbian, Tizen, Bada, etc. Referring to FIG. 3, the programming module 300 may include a kernel 310, a middleware 330, an Application Programming Interface (API) 360, or an application 370.

The kernel 310 (e.g., the kernel 131) may include a system resource manager (not shown) or a device driver (not shown). The system resource manager (not shown) may include a process managing unit (not shown), a memory managing unit (not shown), a file system managing unit (not shown), or the like. The system resource manager 311 may perform control, allocation, retrieval, or the like of the system resource. The device driver 312 may include a display driver (not shown), a camera driver (not shown), a Bluetooth driver (not shown), a shared memory driver (not shown), a USB driver (not shown), a keypad driver (not shown), a WiFi driver (not shown), or an audio driver (not shown). In addition, the device driver may include an Inter-Process Communication (IPC) deriver (not shown).

The middleware 330 may include a plurality of modules pre-implemented to provide a function commonly required by the application 370. In addition, the middleware 330 may provide a function through the API 360 so that the application 370 can effectively use a limited system resource in the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module used by a compiler to add a new function through a programming language while the application 370 is executed. According to one exemplary embodiment, the runtime library 335 may perform a function for input/output, memory management, arithmetic function, etc.

The application manager 341 may manage a life cycle of at least one application among the applications 370. The window manager 342 may manage a Graphic User Interface (GUI) resource used in a screen. The multimedia manager 343 may recognize a format required to reproduce various media files, and may use a code suitable for the format to perform encoding or decoding of the media file. The resource manager 344 may manage a resource (e.g., a source code, memory, storage space, etc.) of at least any one of the applications 370.

The power manager 345 may manage a battery or power by operating together with a Basic Input/Output System (BIOS), etc., and may provide power information, etc., required for the operation. The database manager 346 may manage to generate, search, or change a database to be used in at least one application among the applications 370. The package manager 347 may manage installation or update of an application distributed in a form of a package file.

The connectivity manager 348 may manage a wireless connection such as WiFi, Bluetooth, etc. The notification manager 349 may display or notify an event such as an incoming message, an appointment, a proximity notification, etc., in a manner of not disturbing the user. The location manager 350 may manage location information of the electronic device. The graphic manager 351 may manage a graphic effect to be provided to the user or a user interface related thereto. The security manager 352 may provide a general security function required for system security, user authentication, etc. According to one exemplary embodiment, if the electronic device (e.g., the electronic device 100) has a telephone function, the middleware 330 may further include a telephony manager (not shown) for managing a voice or video telephony function of the electronic device.

The middleware 330 may generate and use a new middleware module by combining various functions of the aforementioned internal constitutional modules. The middleware 330 may provide a module specified for each type of operating system to provide a differentiated function. In addition, the middleware 330 may dynamically delete some of the existing constitutional elements or may add new constitutional elements. Therefore, some of the constitutional elements described in the exemplary embodiment of the present disclosure may be omitted, or other constitutional elements may be further included or may be replaced with constitutional elements having other names for performing a similar function.

The API 360 (e.g., the API 133) is a set of API programming functions, and may be provided with other configurations according to an operating system. For example, in case of Android or IOS, one API set may be provided for each platform, and in case of Tizen, two or more API sets may be provided.

The application 370 (e.g., the application 134) may include a preloaded application or a third party application.

At least some parts of the programming module 300 may be implemented with an instruction stored in a computer-readable storage media. If the instruction is executed by one or more processors (e.g., the processor 210), the one or more processors may perform a function corresponding to the instruction. The computer-readable storage media may be the memory 260. At least some parts of the programming module 300 may be implemented (e.g., executed) by the processor 210. At least some parts of the programming module 300 may include modules, programs, routines, sets of instructions, processes, etc., for performing one or more functions.

Names of constitutional elements of the programming module (e.g., the programming module 300) according to the present disclosure may vary depending on a type of operating system. In addition, the programming module according to the present disclosure may further include at least one or more constitutional elements among the aforementioned constitutional elements, or may omit some of them, or may further include additional other constitutional elements.

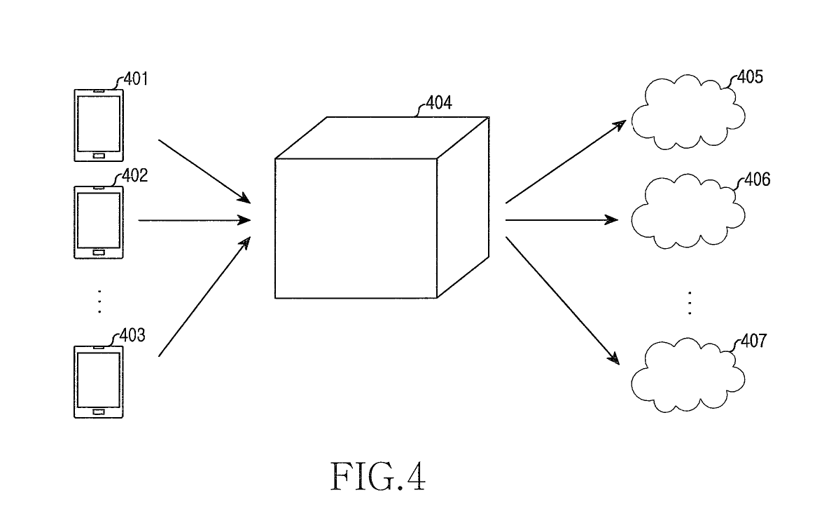

FIG. 4 is a diagram illustrating an overall description of an electronic device capable of integrally searching for an application according to an exemplary embodiment of the present disclosure. Referring to FIG. 4, the present disclosure may include a plurality of electronic devices 401, 402, and 403, a server 404, and a plurality of stores 405, 406, and 407.

First, the server 404 may collect, classify, and store metadata information regarding a plurality of applications stored in the plurality of stores 405, 406, and 407. More specifically, the server 404 may access the plurality of registered stores 405, 406, and 407 to collect metadata information regarding the plurality of applications stored respectively in the stores 405, 406, and 407, and may classify the collected metadata information according to a pre-set category to store the classified information. Herein, the server 404 may collect and store updated metadata information regarding the plurality of applications on a real-time basis. More specifically, the server 404 may access the plurality of registered stores 405, 406, and 407 to collect and store updated metadata information regarding the plurality of applications stored respectively in the stores 405, 406, and 407.

Herein, the metadata information may be application name information, application vender information, application registration information, application version information, information regarding the number of application reviews, application rating information, application support operating system information, application support language information, application usage age information, etc.

Thereafter, the server 404 may receive application group information including information on at least one interested application from the first electronic device 401. That is, the server 404 may receive application group information including information on a plurality of interested applications from the first electronic device 401 which recommends the interested application. Herein, the information on the application may be application Uniform Resource Locator (URL) information, application name information, application packet information, application description information, application screenshot information, etc. In addition, the application group information may include application group name information, application category information, application editor information, application tag information, application description information, application update information, etc.

Thereafter, by comparing metadata information regarding a stored application on the basis of URL information of an extracted interested application, the server 404 may map applications, which are related to respective interested applications, to the respective interested applications. More specifically, the server 404 may store application group information received from the first electronic device 401, may classify the stored application group information according to a pre-set category, and thereafter may extract URL information of each interested application included in the classified application group information. Thereafter, by comparing the metadata information regarding the stored application on the basis of the URL information of the extracted interested application, the server 404 may map applications, which are related to respective interested applications, to the respective interested applications.

Thereafter, the server 404 may receive a request of data regarding at least one piece of application group information from the second electronic device 402 among a plurality of pieces of application group information. More specifically, the server 404 may receive a request of at least one piece of application group information among a plurality of pieces of application group information recommended by the first electronic device 401 from the second electronic device 402 which intends to receive a recommendation on an application.

Thereafter, the server 404 may transmit data regarding the requested application group information by reflecting option information configured to the second electronic device 402 and updated metadata information. More specifically, the server 404 may confirm at least one interested application included in application group information requested from the second electronic device 402, and thereafter may determine whether the second electronic device 402 has an account for a store in which the confirmed interested application is stored. If it is determined that the second electronic device 402 has the account for the store in which the interested application is stored, the server 404 may transmit the information on the interested application to the second electronic device 402.

For example, take a case, for example, where the server 404 receives a request of data regarding application group information stored in the first store 405 from the second electronic device 402, and the requested application group includes an “A application”.

In the aforementioned example, the server 404 may confirm the “A application” which is an interested application included in application group information requested from the second electronic device 402, and thereafter may determine whether the second electronic device 402 has an account for the first store 405 in which the “A application” is stored. If the server 404 determines that the second electronic device 402 has the account for the first store 405, the server 404 may transmit information on the “A application” to the second electronic device 402. That is, the server 404 may transmit a name of the “A application” URL information of the “A application”, etc., to the second electronic device 402.

However, if the server 404 determines that the second electronic device 402 does not have the account for the store in which the interested application is stored, the server 404 may transmit information regarding an application related to the interested application to the second electronic device 402. Herein, the option information may be automatic replace information, dynamic search information, etc. In addition, if the second electronic device 402 does not have an account capable of accessing a store in which an interested application is registered, the automatic replace information may be information regarding whether to replace the interested application to an application related to the interested application among applications stored in another store which has an account accessible by the second electronic device 402. In addition, the dynamic search information may be information regarding whether to update application group information transmitted from the first electronic device 401.

For example, take a case, for example, where the server 404 receives a request of data regarding application group information stored in the first store 405 from the second electronic device 402, and a “B application” is included in a requested application group. In addition, take a case, for example, where the second electronic device 402 does not have an account for the first store 405 but has an account for the second store 406. In addition, take a case, for example, where as a result of confirming option information in the server 404, if the second electronic device 402 does not have an account capable of accessing a store in which an interested application is registered, the second electronic device 402 is configured to replace the interested application to an application related to the interested application among applications stored in another store having an accessible account, and is configured to update application group information.

In the above example, the server 404 may confirm the “B application” which is the interested application included in the application group information requested from the second electronic device 402, and thereafter may determine whether the second electronic device 402 has an account for the first store 405 in which the “B application” is stored. Thereafter, after determining that the second electronic device 402 does not have the account for the first store 405, the server 404 may transmit information regarding a “C application” which is an application related to the “B application” mapped in advance to the second electronic device 402. That is, the server 404 may transmit a name of the “C application” which is an application related to the “B application” stored in the second store 406 accessible by the second electronic device 402, URL information of the “C application” etc., to the second electronic device 402.

Among the plurality of electronic devices 401, 402, and 403 according to the present disclosure, the first electronic device 401 may receive application group information including a plurality of interested applications and may transmit the received application group information to the server 404 so that other electronic devices 402 and 403 can utilize it. Herein, the information on the application may be URL information of the application, application name information, application package name information, application description information, application screenshot information, etc. In addition, the application group information may be application group name information, application category information, application editor information, application tag information, application description information, application update information, etc.

In addition, the first electronic device 401 may receive operation information, i.e., automatic replace information, dynamic search information, etc., together with the application group information. Herein, if the second electronic device 402 does not have an account capable of accessing a store in which an interested application is registered, the automatic replace information may be information regarding whether to replace the interested application to an application related to the interested application among applications stored in another store which has an account accessible by the second electronic device 402. In addition, the dynamic search information may be information regarding whether to update application group information transmitted from the server 404.

That is, the first electronic device 401 may be an electronic device used by a user who recommends an application according to a preset format so that other electronic devices 402 and 403 can easily search for and download the recommended application.

Thereafter, the first electronic device 401 may edit application group information by accessing the server 404, and if the application group information is updated, may receive information notifying that the application group information is updated from the server 404.

When application group information including information on at least one interested application is searched for and selected by accessing the server 404, the second electronic device 402 may receive data regarding at least one piece of application group information among a plurality of application group information from the server 404. More specifically, upon selection of the at least one piece of application group information among the plurality of pieces of application group information, the second electronic device 402 may request the server 404 to send the data regarding the selected at least one piece of application group information and then may receive the data. That is, the second electronic device 402 may be an electronic device which intends to search for application group information recommended by the first electronic device 401 and to download a desired application.

Thereafter, the second electronic device 402 may download an interested application and at least one application among applications related to the interested application from a store connected to the server 404 on the basis of the received data.

First, if the interested application selected by the second electronic device 402 is stored in a store accessible by the second electronic device 402, the second electronic device 402 may download a name of an interested application and URL information indicating a location at which the interested application is stored from the server 404. Thereafter, the second electronic device may access the store in which the interested application is stored, and may download the interested application from the accessed store.

However, if the interested application selected by the second electronic device 402 is stored in a store inaccessible by the second electronic device 402, the second electronic device 402 may download a name of an application related to an interested application and URL information indicating a location at which an application related to the interested application is stored from the server 404. Thereafter, the second electronic device 402 may access a store in which the application related to the interested application is stored, and may download the application related to the interested application from the accessed store.

A user of the conventional electronic device has to experience inconvenience of manually searching for various applications one by one and directly selecting and purchasing an application desired by the user. In addition, in reality, it is difficult for the user of the electronic device to find an account capable of accessing all stores which sell the application, and thus there is a limitation in that the various applications cannot be searched for and purchased by accessing the all stores.

However, from the perspective of a user who recommends and uses the electronic device of the present disclosure, it is enough to provide an application list to be recommended according to a pre-set format to provide the application list updated on a real-time basis to another user, which has an advantage in that various demands of the user can be satisfied. In addition, from the perspective of a user who searches for an application and uses the electronic device of the present disclosure, an application list written in a pre-set format can be provided and the application can be easily searched for, and thus an application related to an application provided from a store inaccessible by the user can be provided, thereby advantageously improving user convenience.

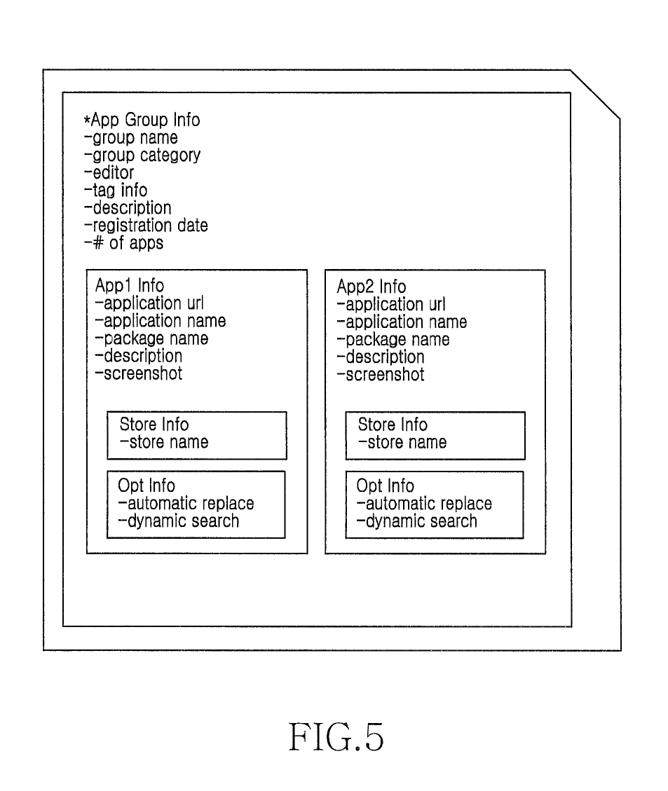

FIG. 5 illustrates an example of application group information according to an exemplary embodiment of the present disclosure. Referring to FIG. 5, the application group information according to the present disclosure may be written by a user who intends to recommend an application, and may be read by a user who intends to receive a recommendation on the application.

First, the application group information may include information on an application group name, a group category, group editor information, tag information (info) including tag information indicating a group, group description information indicating a group description, group update information indicating a group update time, and the number of applications (apps) included in the group.

In addition, each piece of application information included in application group information may include application URL information including an application URL, application name information including an application name, package name information including an actual package name of the application, application description information including application descriptions, screenshot information including an application screenshot, etc.

Option information may be automatic replace information, dynamic search information, etc. Herein, if the electronic device does not have an account capable of accessing a store in which an interested application is registered, the automatic replace information may be information regarding whether to replace the interested application to an application related to the interested application among applications stored in another store which has an account accessible by the electronic device. In addition, the dynamic search information may be information regarding whether to update application group information transmitted from the electronic device.

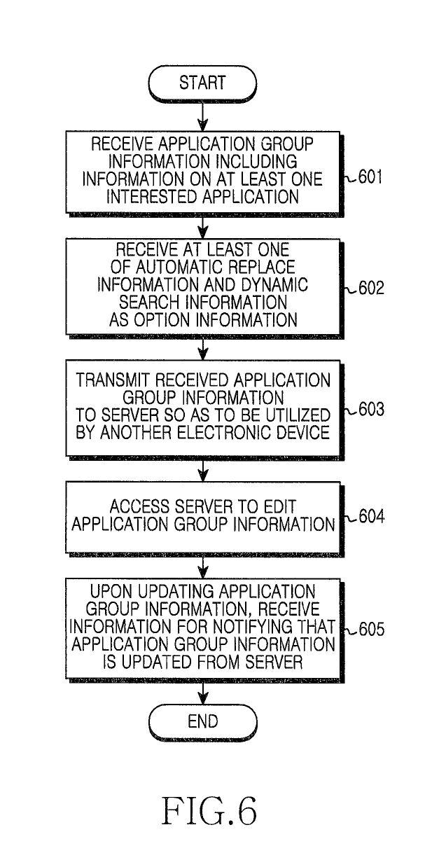

FIG. 6 is a flowchart illustrating an operation of an electronic device for recommending an interested application according to an exemplary embodiment of the present disclosure. First, referring to FIG. 6, the electronic device may receive application group information including information on at least one interested application (step 601). More specifically, the electronic device may receive an interested application of a user according to a pre-set format so that another user can easily search for information regarding the application. Herein, the application group information may include application group name information, application category information, application editor information, application tag information, application description information, application update information, etc. In addition, the application group information may be application group name information, application category information, application editor information, application tag information, application description information, application update information, etc.

Thereafter, the electronic device may receive at least one of automatic replace information and dynamic search information as option information (step 602). Herein, if another electronic device does not have an account capable of accessing a store in which an interested application is registered, the automatic replace information may be information regarding whether to replace the interested application to an application related to the interested application among applications stored in another store which has an account accessible by the another electronic device. In addition, the dynamic search information may be information regarding whether to update application group information transmitted from the server

Thereafter, the electronic device may transmit the received application group information to a server so that another electronic device can utilize the application group information (step 603). That is, the electronic device may recommend an application according to a pre-set format, and may transmit the received application group information to the server so that the recommended application is easily searched for and downloaded by another electronic device.

Thereafter, the electronic device may access the server to edit the application group information (step 604). That is, the electronic device may perform an operation of deleting or adding a variety of information included in the application group information recommended by a user's input.

Thereafter, if the application group information is updated, the electronic device may receive information for notifying that the application group information is updated from the server (step 605). That is, in the server, a plurality of stores accessible on a real-time basis are accessed to determine whether there is a need to update application group information registered by the electronic device, and thereafter if the update is necessary, may transmit a result of performing an operation of adding, deleting, etc., on new application information with respect to the application group information to the electronic device.

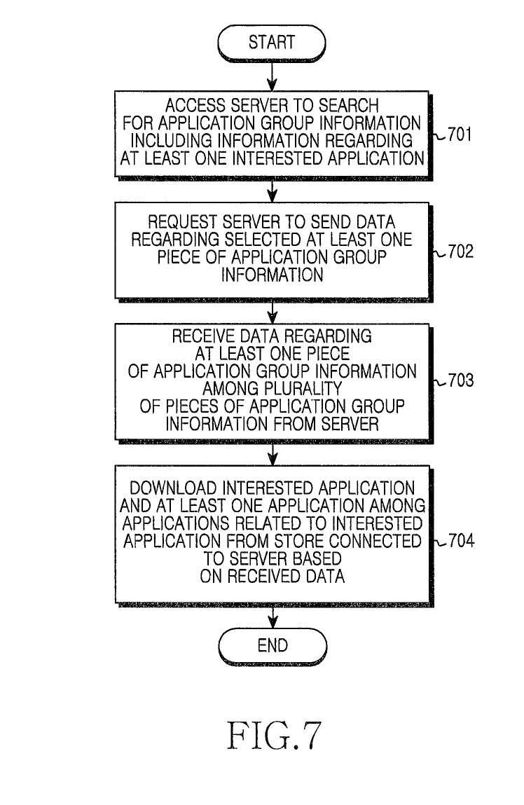

FIG. 7 is a flowchart illustrating an operation of an electronic device for searching for an interested application according to an exemplary embodiment of the present disclosure. First, referring to FIG. 7, the electronic device may access a server to search for application group information including information regarding at least one interested application (step 701). That is, the electronic device may search for application group information classified according to a category, and thus may search for an interested application desired by a user in a fast and convenient manner.

Thereafter, the electronic device may request the server to send data regarding selected at least one piece of application group information (step 702). That is, upon selection of at least one piece of application group information among a plurality of pieces of application group information, the electronic device requests the server to send the data regarding the selected at least one piece of application group information.

Thereafter, the electronic device may receive the data regarding the at least one piece of application group information among the plurality of pieces of application group information from the server (step 703). That is, the electronic device may receive a name of an interested application and URL information indicating a location of the interested application from the server.

Thereafter, the electronic device may download an interested application and at least one application among applications related to the interested application from a store connected to the server on the basis of the received data (step 704). First, if the interested application selected by the electronic device is stored in a store accessible by the electronic device, the electronic device may download the name of the interested application and the URL information indicating the location at which the interested application is stored from the server. Thereafter, the electronic device may access the store in which the interested application is stored, and may download the interested application from the accessed store. However, if the interested application selected by the electronic device is stored in a store inaccessible by the electronic device, the electronic device may download a name of an application related to the interested application and URL information indicating a location at which the application related to the interested application is stored from the server. Thereafter, the electronic device may access the store in which the application related to the interested application is stored, and may download the application related to the interested application from the accessed store.

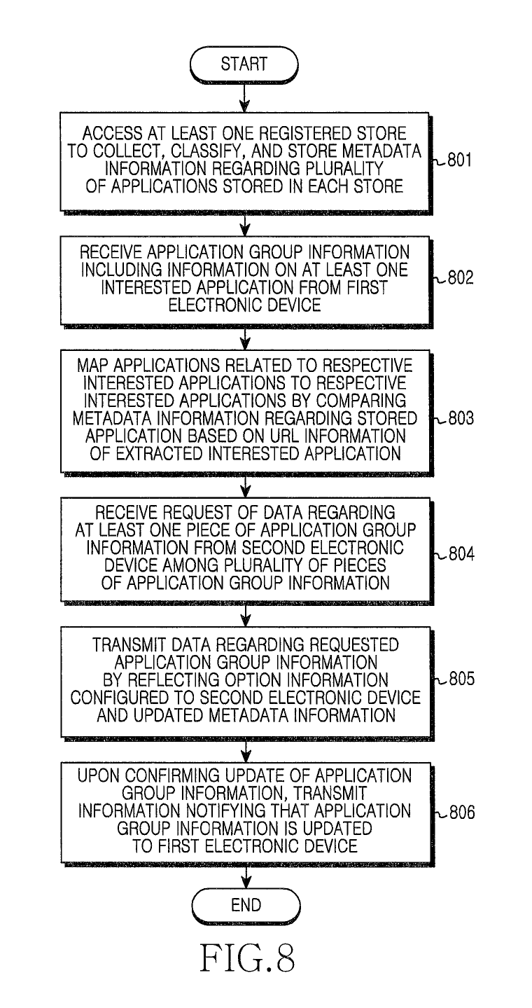

FIG. 8 is a flowchart illustrating an operation of a server according to an exemplary embodiment of the present disclosure. First, referring to FIG. 8, the server may access at least one registered store to collect, classify, and store metadata information regarding a plurality of applications stored in each store (step 801). More specifically, the server may access the plurality of registered stores to collect the metadata information regarding the plurality of allocations stored in each store, classify the collected metadata information according to a pre-set category, and store the classified information.

Thereafter, the server may receive application group information including information on at least one interested application from the first electronic device (step 802). That is, the server may receive application group information including information on a plurality of interested applications from the first electronic device which recommends the interested application.

Thereafter, by comparing metadata information regarding a stored application on the basis of URL information of an extracted interested application, the server may map applications, which are related to respective interested applications, to the respective interested applications (step 803). More specifically, the server may store application group information received from the first electronic device, may classify the stored application group information according to a pre-set category, and thereafter may extract URL information of each interested application included in the classified application group information. Thereafter, by comparing the metadata information regarding the stored application on the basis of the URL information of the extracted interested application, the server may map applications, which are related to respective interested applications, to the respective interested applications.

Thereafter, the server may receive a request of data regarding at least one piece of application group information from the second electronic device among a plurality of pieces of application group information (step 804). More specifically, the server may receive a request of at least one piece of application group information among a plurality of pieces of application group information recommended by the first electronic device from the second electronic device which intends to receive a recommendation on an application.

Thereafter, the server may transmit data regarding the requested application group information by reflecting option information configured to the second electronic device and updated metadata information (step 805). More specifically, the server may confirm at least one interested application included in application group information requested from the second electronic device, and thereafter may determine whether the second electronic device has an account for a store in which the confirmed interested application is stored. If it is determined that the second electronic device has the account for the store in which the interested application is stored, the server may transmit the information on the interested application to the second electronic device. However, if the server determines that the second electronic device does not have the account for the store in which the interested application is stored, the server may transmit information regarding an application related to the interested application to the second electronic device.

Thereafter, if it is confirmed that application group information is updated, the server may transmit information notifying that the application group information is updated to the first electronic device (step 806). That is, in the server, a plurality of stores accessible on a real-time basis are accessed to determine whether there is a need to update application group information registered by the first electronic device, and thereafter if the update is necessary, may transmit a result of performing an operation of adding, deleting, etc., on new application information with respect to the application group information to the first electronic device.

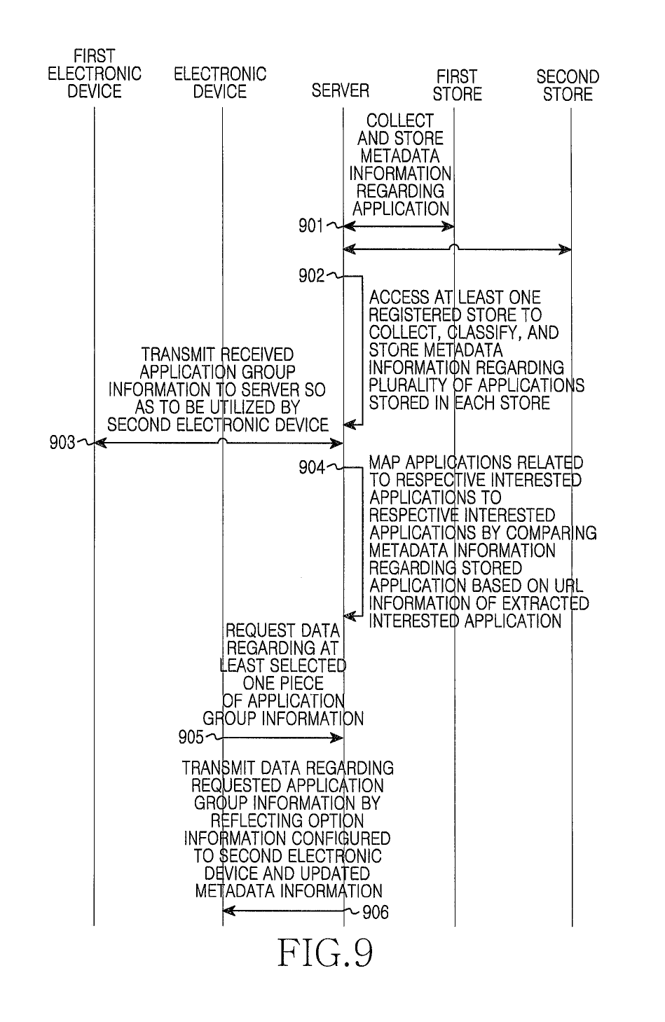

FIG. 9 is a flowchart illustrating an electronic device capable of integrally searching for an application according to an exemplary embodiment of the present disclosure. First, referring to FIG. 9, a server may access each of a first store and a second store to collect and store metadata information regarding an application (step 901). More specifically, the server may access a plurality of registered stores to collect metadata information regarding a plurality of applications stored in each store, and may classify the collected metadata information according to a pre-set category.

Thereafter, the server may access at least one registered store to collect, classify, and store metadata information regarding a plurality of applications stored in each store (step 902). That is, the server may store classified each metadata information.

Thereafter, the electronic device may transmit the received application group information to the server so that a second electronic device can utilize it (step 903). That is, the electronic device may recommend an application according to a pre-set format, and may transmit the received application group information to the server so that the recommended application is easily searched for and downloaded by the second electronic device.

Thereafter, by comparing metadata information regarding a stored application on the basis of URL information of an extracted interested application, the server may map applications, which are related to respective interested applications, to the respective interested applications (step 904). More specifically, the server may store application group information received from the first electronic device, may classify the stored application group information according to a pre-set category, and thereafter may extract URL information of each interested application included in the classified application group information. Thereafter, by comparing the metadata information regarding the stored application on the basis of the URL information of the extracted interested application, the server may map applications, which are related to respective interested applications, to the respective interested applications.

Thereafter, the electronic device may request data regarding at least selected one piece of application group information (step 905). That is, upon selection of at least one piece of application group information among a plurality of pieces of application group information, the electronic device may request the server to send the data regarding at least selected one piece of application group information.

Thereafter, the server may transmit data regarding the requested application group information by reflecting option information configured to the second electronic device and updated metadata information (step 906). More specifically, the server may confirm at least one interested application included in application group information requested from the second electronic device, and thereafter may determine whether the second electronic device has an account for a store in which the confirmed interested application is stored. If it is determined that the second electronic device has the account for the store in which the interested application is stored, the server may transmit the information on the interested application to the second electronic device. However, if the server determines that the second electronic device does not have the account for the store in which the interested application is stored, the server may transmit information regarding an application related to the interested application to the second electronic device.

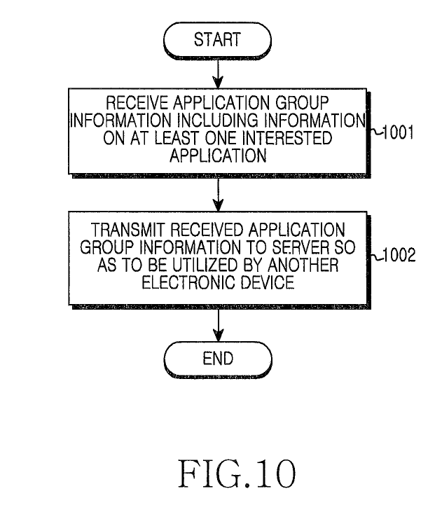

FIG. 10 is a flowchart illustrating a method of an electronic device for recommending an interested application according to an exemplary embodiment of the present disclosure. First, referring to FIG. 10, the electronic device may receive application group information including information on at least one interested application (step 1001). More specifically, the electronic device may receive an interested application of a user according to a preset format so that another user can easily search for information regarding the application. Herein, the application group information may include application group name information, application category information, application editor information, application tag information, application description information, application update information, etc. In addition, the application group information may be application group name information, application category information, application editor information, application tag information, application description information, application update information, etc.

Thereafter, the electronic device may transmit the received application group information to a server so that another electronic device can utilize it (step 1003). That is, the electronic device may recommend an application according to a pre-set format, and may transmit the received application group information to the server so that the recommended application is easily searched for and downloaded by another electronic device. Thereafter, the electronic device may access the server to edit application group information, and if the application group information is updated, may receive information for notifying that the application group information is updated from the server.

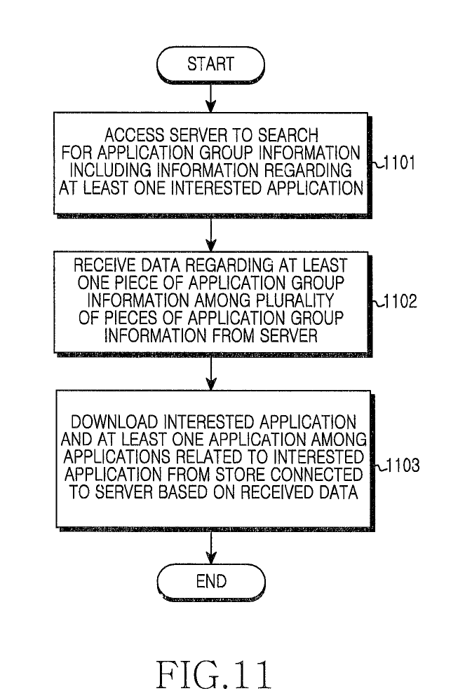

FIG. 11 is a flowchart illustrating a method of an electronic device for searching for an interested application according to an exemplary embodiment of the present disclosure. First, referring to FIG. 11, the electronic device may access a server to search for application group information including information regarding at least one interested application (step 1101). That is, the electronic device may search for application group information classified according to a category, and thus may search for an interested application desired by a user in a fast and convenient manner.

Thereafter, the electronic device may receive the data regarding the at least one piece of application group information among the plurality of pieces of application group information from the server (step 1102). That is, upon selection of at least one piece of application group information among a plurality of pieces of application group information, the electronic device may request the server to send the data regarding at least selected one piece of application group information, and may receive a name of an interested application and URL information indicating a location of the interested application from the server.

Thereafter, the electronic device may download an interested application and at least one application among applications related to the interested application from a store connected to the server on the basis of the received data (step 1103). First, if the interested application selected by the electronic device is stored in a store accessible by the electronic device, the electronic device may download the name of the interested application and the URL information indicating the location at which the interested application is stored from the server. Thereafter, the electronic device may access the store in which the interested application is stored, and may download the interested application from the accessed store. However, if the interested application selected by the electronic device is stored in a store inaccessible by the electronic device, the electronic device may download a name of an application related to the interested application and URL information indicating a location at which the application related to the interested application is stored from the server. Thereafter, the electronic device may access the store in which the application related to the interested application is stored, and may download the application related to the interested application from the accessed store.

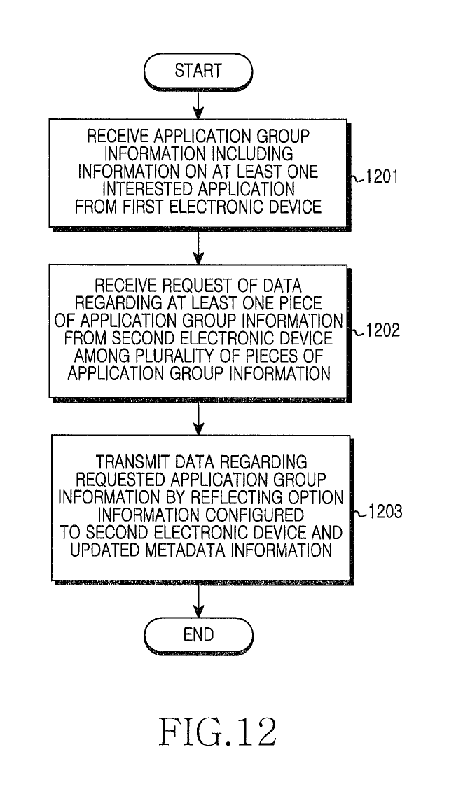

FIG. 12 is a flowchart illustrating a method of a server according to an exemplary embodiment of the present disclosure. First, referring to FIG. 12, the server may receive application group information including information on at least one interested application from the first electronic device (step 1201). That is, the server may access the plurality of registered stores to collect the metadata information regarding the plurality of allocations stored in each store, classify the collected metadata information according to a pre-set category, and store the classified information. Thereafter, the server may receive application group information including information on a plurality of interested applications from the first electronic device which recommends the interested application.

Thereafter, the server may receive a request of data regarding at least one piece of application group information from the second electronic device among a plurality of pieces of application group information (step 1202). More specifically, after extracting URL information of each interested application included in classified application group information, the server may receive a request of at least one piece of application group information among a plurality of pieces of application group information recommended by the first electronic device from the second electronic device which intends to receive a recommendation on an application.

Thereafter, the server may transmit data regarding the requested application group information by reflecting option information configured to the second electronic device and updated metadata information (step 1203). More specifically, the server may confirm at least one interested application included in application group information requested from the second electronic device, and thereafter may determine whether the second electronic device has an account for a store in which the confirmed interested application is stored. If it is determined that the second electronic device has the account for the store in which the interested application is stored, the server may transmit the information on the interested application to the second electronic device. However, if the server determines that the second electronic device does not have the account for the store in which the interested application is stored, the server may transmit information regarding an application related to the interested application to the second electronic device. Thereafter, if it is confirmed that application group information is updated, the server may transmit information notifying that the application group information is updated to the first electronic device.

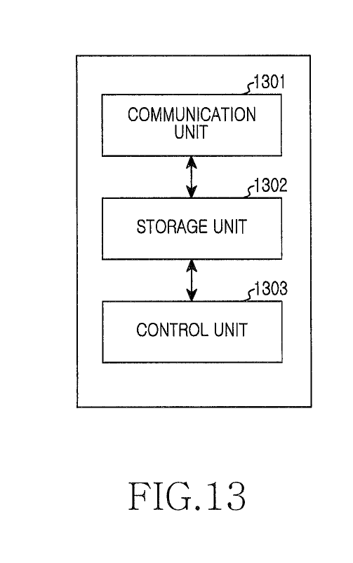

FIG. 13 is a block diagram illustrating a structure of a server according to an exemplary embodiment of the present disclosure. First, referring to FIG. 13, the server may include a communication unit 1301, a storage unit 1302, and a control unit 1303.

The communication unit 1301 may process a signal transmitted/received through an antenna for voice and data communication. For example, the communication unit 1301 may receive application group information including information on at least one interested application from the first electronic device, may receive a request of data regarding at least one piece of application group information from the second electronic device among a plurality of pieces of application group information, and may transmit data regarding the requested application group information by reflecting option information configured to the second electronic device and updated metadata information. In addition, if it is determined that the second electronic device has the account for the store in which the interested application is stored, the communication unit 1301 may transmit the information on the interested application to the second electronic device. In addition, if it is determined that the second electronic device does not have the account for the store in which the interested application is stored, the communication unit 1301 may transmit information regarding an application related to the interested application to the second electronic device. In addition, the communication unit 1301 may transmit information notifying that the application group information is updated to the first electronic device.

The storage unit 1302 may include a program storage unit which stores a program for controlling the operation of the server and a data storage unit which stores data generated during the program is executed. For example, the storage unit 1302 may store classified information, may access registered at least one store to collect and store updated metadata information for a plurality of applications stored in each store, and may store the application group information received from the first electronic device.

The control unit 1303 may provide overall control to the server. For example, the control unit 1303 may access at least one registered store to collect metadata information regarding a plurality of applications stored in each store, and may classify the collected metadata information according to a pre-set category. In addition, the control unit 1303 may classify the stored application group information according to a pre-set category, and thereafter may extract URL information of each interested application included in the classified application group information. Thereafter, by comparing metadata information regarding a stored application on the basis of URL information of an extracted interested application, the control unit 1303 may map applications, which are related to respective interested applications, to the respective interested applications. In addition, the control unit 1303 may confirm at least one interested application included in application group information requested from the second electronic device, may determine whether the second electronic device has an account for a store in which the confirmed interested application is stored, and may confirm that the application group information is updated.

In the aforementioned structure, the control unit 1303 may perform an overall function of the server. However, these functions are separately configured and illustrated in the present disclosure to describe the respective functions separately. Therefore, when the product is implemented in practice, all functions of the server may be processed by the control unit 1303 or only some of the functions thereof may be processed by the control unit 1303.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of operating an electronic device, the method comprising:
receiving application group information including information on at least one interested application; and
transmitting the received application group information to a server so that another electronic device can utilize the information.

2. The method of claim 1, wherein the information on the at least one interested application includes at least one of application Uniform Resource Locator (URL) information, application name information, application package name information, application description information, or application screenshot information.

3. The method of claim 1, wherein the application group information includes at least one of application group name information, application category information, application editor information, application tag information, application description information, or application update information.

4. The method of claim 1, further comprising receiving at least one of automatic replace information or dynamic search information as option information.

5. The method of claim 4, wherein when the another electronic device does not have an account capable of accessing a store in which the interested application is registered, the automatic replace information includes information regarding whether to replace the at least one interested application with an application related to the at least one interested application among applications stored in another store which has an account accessible by the second electronic device.

6. The method of claim 4, wherein the dynamic search information includes information regarding whether to update application group information transmitted from the server.

7. The method of claim 1, further comprising editing the application group information by accessing the server.

8. The method of claim 1, further comprising, in response to the application group information being updated, receiving information notifying that the application group information is updated from the server.

9. A method of operating an electronic device, the method comprising:
accessing a server to search for application group information including information on at least one interested application;
receiving data regarding at least one piece of the application group information from the server among a plurality of pieces of the application group information; and
downloading an interested application and at least one application among applications related to the interested application from a store connected to the server based on the received data.

10. The method of claim 9, wherein the information on the at least one interested application includes at least one of application Uniform Resource Locator (URL) information, application name information, application package name information, application description information, or application screenshot information.

11. The method of claim 9, wherein the application group information includes at least one of application group name information, application category information, application editor information, application tag information, application description information, or application update information.

12. The method of claim 9, further comprising:
receiving at least one piece of the application group information selected from the plurality of pieces of the application group information; and
requesting data regarding the selected at least one piece of application group information to the server.

13. The method of claim 9, wherein downloading the interested application and the at least one application among applications related to the interested application from the store connected to the server based on the received data comprises:
in response to identifying that the received data includes information on the interested application, accessing a store in which the interested application is stored;
requesting the accessed store to download the interested application; and
downloading the interested application from the accessed store.

14. The method of claim 9, wherein downloading the interested application and the at least one application among applications related to the interested application from the store connected to the server based on the received data comprises:
in response to identifying that the received data includes information on an application related to the interested application, accessing a store in which the at least one application related to the interested application is stored;
requesting the accessed store to download the at least one application related to the interested application; and
downloading the at least one application related to the interested application from the accessed store.

15. A method of operating a server, the method comprising:
receiving application group information including information on at least one interested application from a first electronic device;
receiving, from a second electronic device, a request for data regarding at least one piece of the application group information among a plurality of pieces of the application group information; and
transmitting data regarding the at least one piece of the application group information by reflecting option information configured to the second electronic device and updated metadata information.

16. The method of claim 15, further comprising:
accessing at least one registered store to collect metadata information regarding a plurality of applications stored in the at least one registered store;
classifying the collected metadata information according to a preset category; and
storing the classified information.

17. The method of claim 15, further comprising accessing at least one registered store to collect and store metadata information regarding a plurality of applications stored in the at least one registered store.

18. The method of claim 17, wherein the metadata information includes at least one of application name information, application vender information, application registration information, application version information, information regarding the number of application reviews, application rating information, application support operating system information, application support language information, or application usage age information.

19. The method of claim 15, wherein the information on the at least one interested application includes at least one of application Uniform Resource Locator (URL) information, application name information, application package name information, application description information, or application screenshot information.

20. The method of claim 15, wherein the information on the at least one interested application includes application group name information, application category information, application editor information, application tag information, application description information, or application update information.

21. The method of claim 15, wherein the option information includes at least one of automatic replace information and dynamic search information.

22. The method of claim 15, wherein if the second electronic device does not have an account capable of accessing a store in which an interested application is registered, the automatic replace information includes information regarding whether to replace the at least one interested application with an application related to the at least one interested application among applications stored in another store which has an account accessible by the second electronic device.

23. The method of claim 15, wherein the dynamic search information includes information regarding whether to update application group information transmitted from the first electronic device.

24. The method of claim 15, further comprising:
storing the application group information received from the first electronic device;
classifying the stored application group information according to a preset category;
extracting URL information of each interested application included in the classified application group information; and
mapping an application related to each interested application to each interested application, by comparing metadata information regarding a stored application based on URL information of an extracted interested application.

25. The method of claim 15, wherein transmitting the data regarding the at least one piece of the application group information by reflecting the option information configured to the second electronic device and the updated metadata information comprises:
identifying an interested application included in application group information requested from the second electronic device;
determining whether the second electronic device has an account for a store in which the interested application is stored; and
in response to determining that the second electronic device has the account for the store in which the interested application is stored, transmitting information on the interested application to the second electronic device.

26. The method of claim 25, wherein in response to determining that the second electronic device does not have the account for the store in which the interested application is stored, transmitting information on an application related to the interested application to the second electronic device.

27. The method of claim 15, further comprising:
identifying that the application group information is updated; and
transmitting information notifying that the application group information is updated to the first electronic device.

28. An electronic apparatus comprising:
a display unit configured to receive application group information including information on at least one interested application; and
a communication unit configured to transmit the received application group information to a server so that another electronic device can utilize the information.

29. The electronic device of claim 28, wherein the information on the at least one interested application includes at least one of application Uniform Resource Locator (URL) information, application name information, application package name information, application description information, or application screenshot information.

30. The electronic device of claim 28, wherein the application group information includes at least one of application group name information, application category information, application editor information, application tag information, application description information, or application update information.

31. The electronic device of claim 28, wherein the display unit is configured to receive at least one of automatic replace information or dynamic search information as option information.

32. The electronic device of claim 31, wherein when the another electronic device does not have an account capable of accessing a store in which the interested application is registered, the automatic replace information includes information regarding whether to replace the at least one interested application with an application related to the at least one interested application among applications stored in another store which has an account accessible by the second electronic device.

33. The electronic device of claim 31, wherein the dynamic search information includes information regarding whether to update application group information transmitted from the server.

34. The electronic device of claim 28, further comprising a processor configured to edit the application group information by accessing the server.

35. The electronic device of claim 28, wherein in response to the application group information in response to updated, the communication unit is configured to receive information notifying that the application group information is updated from the server.

36. An electronic device comprising:
a processor configured to access a server to search for application group information including information on at least one interested application; and
a communication unit configured to receive data regarding at least one piece of the application group information from the server among a plurality of pieces of application group information, and download an interested application and at least one application among applications related to the interested application from a store connected to the server based on the received data.

37. The electronic device of claim 36, wherein the information on the at least one interested application includes at least one of application Uniform Resource Locator (URL) information, application name information, application package name information, application description information, or application screenshot information.

38. The electronic device of claim 36, wherein the application group information includes at least one of application group name information, application category information, application editor information, application tag information, application description information, or application update information.

39. The electronic device of claim 36, further comprising:
a display unit configured to receive at least one piece of the application group information selected from the plurality of pieces of the application group information,
wherein the communication unit is configured to request the server to send the data regarding the selected at least one piece of application group information.

40. The electronic device of claim 36, wherein when the received data includes information on the interested application, the communication unit is configured to access a store in which the interested application is stored, request the accessed store to download the interested application, and download the interested application from the accessed store.

41. The electronic device of claim 36, wherein when the received data includes information on an application related to the interested application, the communication unit is configured to access a store in which the at least one application related to the interested application is stored, request the accessed store to download the application related to the at least one interested application, and download the application related to the interested application from the accessed store.

42. A server comprising:
a communication unit configured to receive application group information including information on at least one interested application from a first electronic device; receive, from a second electronic device, a request for data regarding the at least one piece of the application group information among a plurality of pieces of the application group information; and transmit data regarding the at least one piece of the application group information by reflecting option information configured to the second electronic device and updated metadata information; and
a storage unit configured to store data controlled in the communication unit.

43. The server of claim 42, further comprising:
a controller configured to access at least one registered store to collect metadata information regarding a plurality of applications stored in the at least one registered store, and classify the collected metadata information according to a preset category,
wherein the storage unit is configured to store the classified information.

44. The server of claim 42, wherein the storage unit is configured to access at least one registered store to collect and store metadata information regarding a plurality of applications stored in the at least one registered store.

45. The server of claim 44, wherein the metadata information includes at least one of application name information, application vender information, application registration information, application version information, information regarding the number of application reviews, application rating information, application support operating system information, application support language information, or application usage age information.

46. The server of claim 42, wherein the information on the at least one interested application includes at least one of application Uniform Resource Locator (URL) information, application name information, application package name information, application description information, or application screenshot information.

47. The server of claim 42, wherein the information on the at least one interested application includes application group name information, application category information, application editor information, application tag information, application description information, or application update information.

48. The server of claim 42, wherein the option information includes at least one of automatic replace information and dynamic search information.

49. The server of claim 42, wherein if the second electronic device does not have an account capable of accessing a store in which an interested application is registered, the automatic replace information includes information regarding whether to replace the at least one interested application with an application related to the at least one interested application among applications stored in another store which has an account accessible by the second electronic device.

50. The server of claim 42, wherein the dynamic search information includes information regarding whether to update application group information transmitted from the first electronic device.

51. The server of claim 42, wherein:
the storage unit is configured to store the application group information received from the first electronic device, and
the server further comprises a controller configured to classify the stored application group information according to a preset category, extract URL information of each interested application included in the classified application group information, and map an application related to each interested application to each interested application, by comparing metadata information regarding a stored application based on URL information of an extracted interested application.

52. The server of claim 42, further comprising:
a controller configured to confirm at least one interested application included in application group information requested from the second electronic device, and determine whether the second electronic device has an account for a store in which the confirmed interested application is stored,
wherein in response to a determination that the second electronic device has the account for the store in which the interested application is stored, the communication unit is configured to transmit information on the interested application to the second electronic device.

53. The server of claim 52, wherein in response to a determination that the second electronic device does not have the account for the store in which the interested application is stored, the communication unit is configured to transmit information on an application related to the interested application to the second electronic device.

54. The server of claim 42, further comprising a controller configured to identify that the application group information is updated, wherein the communication unit is configured to transmit information notifying that the application group information is updated to the first electronic device.
